(19) United States
(12) Patent Application Publication
(10) Pub. No.: US 2010/0034054 A1
(43) Pub. Date: Feb. 11, 2010

(54) Enviromentally Assisted Processor in Sonar

(75) Inventors: Richard Wayland, Leonard town, MD (US); John H. Joseph, Huntingtown, MD (US); Gary Dum, La Plata, MD (US)

Correspondence Address: Department of the Navy;(Naval Air Warfare Center -Aircraft Division), 47076 Lijencreantz Road, B 435, PATUXENT RIVER, MD, 20670, US

(73) Assignee: Sony Ericsson Mobile Communications AB, Lund (SE)

(21) Appl. No.: 12/185,985

(22) Filed: Aug. 5, 2008

(51) Int. Cl. G01S 15/00

(52) U.S. Cl. 367/87

(57) ABSTRACT

An environmentally assisted processor that includes an environmental characterization module, an echo prediction module and an acoustic consistency module. The environmental characterization module obtains surrounding environmental characteristics, and provides inputs of the surrounding environmental characteristics to the echo prediction module. The echo prediction module utilizes the surrounding environmental characteristics to predict echo waveforms of would be targets in that particular local environment. The acoustic consistency module compares an observed echo waveform with predicted echo waveforms, if they are similar the observed echo waveform is determined to be from a target.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to an environmentally assisted processor in sonar. More specifically, but without limitation, the present invention is an environmentally assisted processor in sonar used to decide whether an aquatic sonar detection is an echo off a target or an echo off a non-target.

Previous processors that classify sonar echoes have been statistical in nature. They utilize a historical collection of measured target and non-target detection and the historical knowledge of an ocean bottom. When entering new waters there is little or no data on the ocean bottom.

Currently there are no processors which can determine whether a sonar echo is from a target (enemy submarine and the like) or a non-target. The only guidance a sonar operator has is historical echoes from previous at sea operations. However, historical echoes often are not adequate representations of echoes found in a new area.

For the foregoing reasons, there is a need for a processor capable of helping an operator determine whether a sonar echo is from a target (enemy submarine and the like) or a non-target, especially in previously uncharted waters.

### SUMMARY

The present invention is directed to an environmentally assisted processor in sonar that meets the needs enumerated above and below.

The present invention is directed to an environmentally assisted processor that includes an environmental characterization module, an echo prediction module and an acoustic consistency module. The environmental characterization module obtains surrounding environmental characteristics, and provides inputs of the surrounding environmental characteristics to the echo prediction module. The echo prediction module utilizes the surrounding environmental characteristics to predict echo waveforms of would be targets in that particular local environment. The acoustic consistency module compares an observed echo waveform with predicted echo waveforms, if they are similar the observed echo waveform is determined to be from a target.

It is a feature of the present invention to provide an environmentally assisted processor in sonar that provides a sonar operator with representations of what target echoes should look like in an operating area.

It is a feature of the present invention to provide an environmentally assisted processor in sonar that helps determine whether an aquatic sonar detection is an echo off a target or an echo off a non-target.

### DRAWINGS

These and other features, aspects and advantages of the present invention will become better understood with reference to the following description and appended claims, and accompanying drawings wherein:

FIG. 1 is an embodiment of the environmentally assisted processor;

FIG. 2 is a flow chart showing the operation of the environmentally assisted processor; and,

FIG. 3 is a basic block diagram of the environmentally assisted processor.

### DESCRIPTION

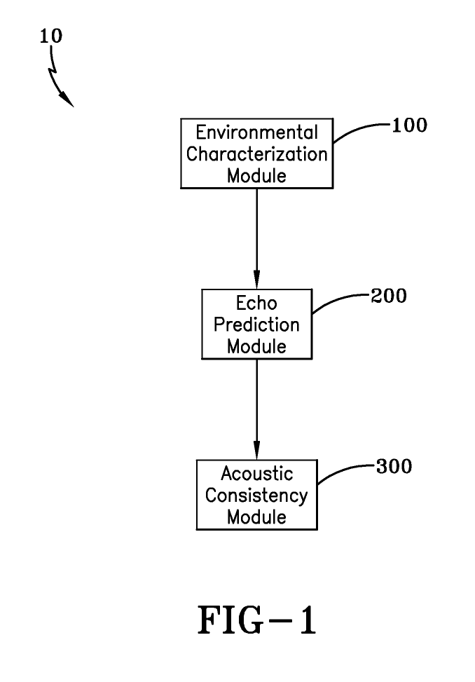

The preferred embodiments of the present invention are illustrated by way of example below and in FIGS. 1-3. The invention is an environmentally assisted processor 10 for determining whether an aquatic sonar detection is an echo off a target or an echo off a non-target. As shown in FIG. 1, the environmentally assisted processor 10 includes an environmental characterization module 100, an echo prediction module 200 and an acoustic consistency module 300. The environmental characterization module 100 obtains surrounding environmental characteristics, and provides inputs of the surrounding environmental characteristics to the echo prediction module. The echo prediction module 200 utilizes the surrounding environmental characteristics to predict echo waveforms of would be targets in that particular local environment. The acoustic consistency module 300 compares an observed echo waveform with predicted echo waveforms, if they are similar the observed echo waveform is determined to be from a target.

In the description of the present invention, the invention will be discussed in a military sonar environment; however, this invention can be utilized for any type of need that requires use of sonar.

The environmental characterization module obtains surrounding environmental characteristics. The surrounding environmental characteristics are typically local ocean properties (properties of the local environment or area of water/ocean). These characteristics form an environmental model of the area. The most important properties are the local sound speed profile (sound speed variation with depth) and the local bottom properties (ocean bottom properties). The environmental characterization module may include a standard bathythermograph (BT) buoy, which measures ocean temperature variation with depth. This temperature variation is then transformed using a standard conversion formula into the required sound speed profile.

To be tactically feasible, bottom properties must be obtained without jeopardizing the search for targets (typically submarines). Therefore, only limited time and assets can be applied to bottom characterization and traditional Naval Oceanographic Office (NAVO) bottom surveys cannot be done because they require days to execute. The environmental characterization module may estimate a bottom model (a characterization of the ocean floor) from the decay of long-time reverberation. In the preferred embodiment, the decay of long-time reverberation may be done through use of a process called tactical reverberation inversion.

The tactical reverberation inversion method estimates the decay of long term reverberation by propagating energy in a specific mode from a source to a scattering patch on the bottom, scattering a portion back toward the source, and then propagating this scattered energy back to the source, the total reverberation is found by summing over all pairs of scattered energy and integrating over the relevant scattering area.

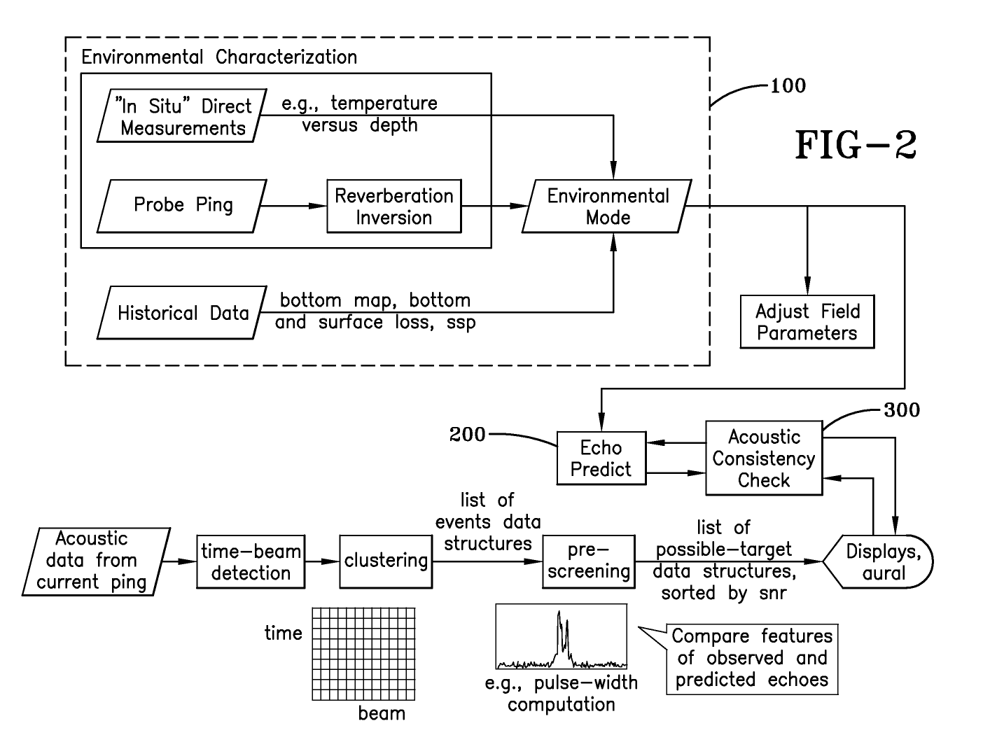

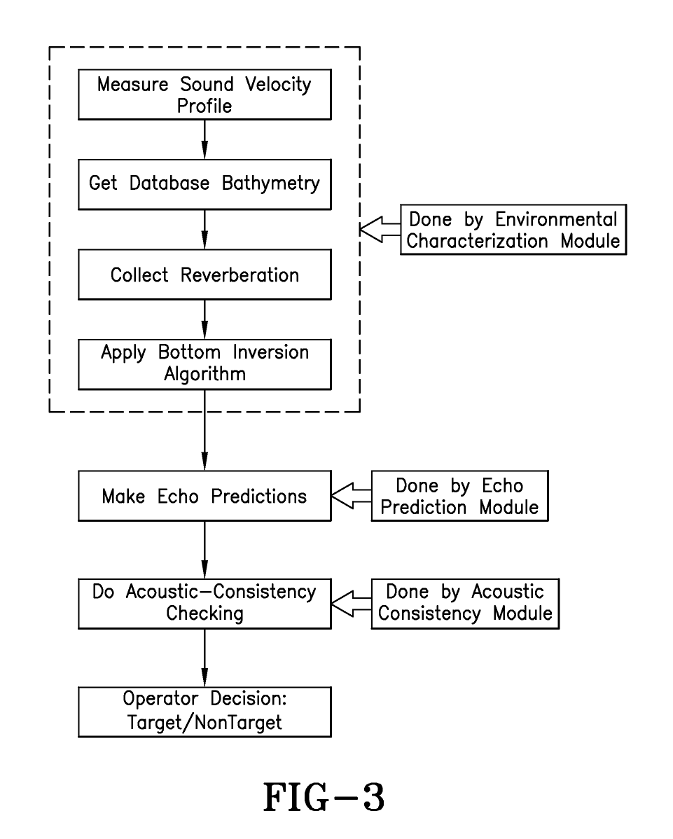

In operation, as seen in FIGS. 2 and 3, the environmental characterization is performed by the environmental characterization module 100 i.e. the environmental model is built by the environmental characterization module 100. The environmental characterization module 100 may utilize in situ “direct” measurements. One of these direct measurements includes the local sound speed profile (obtained by directly measuring temperature versus depth). Sonar probe pings are sent by the operator, which are used to perform the tactical reverberation inversion, as described above. Along with any historical data, the in situ measurements, and the results from the tactical reverberation inversion, an environmental model is made by the environmental characterization module 100. The various filed parameters may be adjusted, if desired. The environmental model is then communicated to the echo prediction module, which creates (predicts) a list of possible target data structures describing potential target echoes. The echo prediction module 200 predicts several possible target echo (in military situations typically types of submarine echos) at different hypothesized depths. These predicted echoes are then compared to the observed (actual) echo and displayed to the operator by the acoustic consistency module 300. The operator, by comparing the observed echo to the predicted echoes can then determine if the observed echo is from a target or a non target.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. An environmentally assisted processor for determining whether an aquatic sonar detection is an echo off a target or off a non-target, the environmentally assisted processor comprising:
an environmental characterization module, the environmental characterization module obtaining surrounding environmental characteristics;
an echo prediction module, the environmental characterization module providing inputs of the surrounding environmental characteristics to the echo prediction module, the echo prediction module utilizing the surrounding environmental characteristics to predict echo waveforms of would be targets; and,
an acoustic consistency module, the acoustic consistency module compares an observed echo waveform with the predicted echo waveforms, if they are similar the observed echo waveform is determined to be from a target.

2. The environmentally assisted processor of claim 1, whereby the surrounding environmental characteristics are a local sound speed profile (sound speed variation with depth) and local bottom properties.

3. The environmentally assisted processor of claim 2, wherein the environmental characterization module includes a standard bathythermograph buoy for measuring water temperature variation with depth, the water temperature variation is converted into the local sound speed profile.

4. The environmentally assisted processor of claim 2, wherein the local bottom properties are obtained by estimating the bottom from the decay of long term reverberation.

5. The environmentally assisted processor of claim 4, wherein the decay of long term reverberation is estimated by propagating energy in a specific mode from a source to a scattering patch on the bottom, scattering a portion back toward the source, and then propagating this scattered energy back to the source, the total reverberation is found by summing over all pairs scattered energy and integrating over the relevant scattering area.

6. A method for determining whether an aquatic sonar detection is an echo off a target or off a non-target, the method comprising:
obtaining surrounding environmental characteristics;
predicting echo waveforms of would be targets by utilizing the surrounding environmental characteristics; and,
comparing an observed echo waveform with the predicted echo waveforms, if they are similar, the observed echo waveform is determined to be from a target.

7. The method of claim 6 wherein the method further includes local bottom properties are obtained by estimating the bottom from the decay of long-time reverberation.

8. The method of claim 7, wherein the decay of long term reverberation is estimated by propagating energy in a specific mode from a source to a scattering patch on the bottom, scattering a portion back toward the source, and then propagating this scattered energy back to the source, the total reverberation is found by summing over all pairs scattered energy and integrating over the relevant scattering area.
